(19) United States
(12) Patent Application Publication
(10) Pub. No.: US 2026/0028549 A1
(43) Pub. Date: Jan. 29, 2026

(54) TREATMENT PROCESS OF USED FILTRATION EARTH IN THE VEGETABLE FATS AND BIOFUELS SECTOR

(71) Applicant: ALCHEMY VENTURES AND DEVELOPMENTS SAS, Bogota (CO)

(72) Inventors: Oscar Augusto ARIZA GALEANO, Bogota (CO); Andres GUZMAN ROCHA, Bogota (CO); Juan Carlos FLOREZ, Bogota (CO)

(21) Appl. No.: 18/997,205

(22) PCT Filed: Jul. 19, 2022
(86) PCT No.: PCT/IB2022/054232

§ 371 Date: Jan. 21, 2025

(51) Int. Cl. C11B 13/04; B01J 20/12

(52) U.S. Cl. CPC C11B 13/04; B01J 20/12

(57) ABSTRACT

The present invention relates to an industrial process for the treatment of used filtration earths in the vegetable fats and biofuels sector, to recover fats, earths and other valuable components. Thus, the process of the invention allows the recovery of fats, without the use of hydrocarbons as solvents and of the lesser components found in the earths, as well as the subsequent use of the earths.

### OBJECT OF THE INVENTION

The present invention relates to an industrial process for treating earths used for filtration in the vegetable fats and biofuels sector, with the aim of recovering fats, earths and other valuable components.

In particular, the present invention relates in a general manner to an industrial process that includes the preparation of aqueous solution A using 1 to 10 times in Kg with respect to the earth in Kg, where the solution is mainly composed of hot water, pH regulating additive, anti-emulsifier and a mono-alcohol or poly-alcohol or mixtures thereof.

The used filtration earths are added to a stirred reactor that previously has an aqueous solution A, with stirring and at a determined temperature and time, subsequently the product that is in the reactor is subjected to a separation process and three currents emerge; stream A: Bottom Earths, stream B-1: Water and interface and stream C: supernatant organic materials.

The treatment of Stream A, if required, is subjected to washing with water at temperature and agitation in a reactor that allows the dispersion of the earth, subsequently, it is passed to a solids decantation system and two streams emerge; stream D: Washed earth and stream B-2: washing water.

The treatment of Stream C, if required, is sent to washing by different methods, mixer and dynamic, column washing, washing with a packed column or drip washing at temperature and from this process two streams emerge; stream E: light phase of organic material and stream B-3: washing water.

The treatment of Stream E is carried out in vacuum drying equipment at a temperature and two streams emerge from this stage: stream F and B-4.

The treatment of Stream D is subjected to solids drying by different methods, such as thermal belt, rotary kiln or any other method available for drying solids, leaving Product 1, dry recovered earth.

The treatment of Stream F is allowed to cool and is subsequently mixed in a reactor with agitation of Product 1. It is passed through a filtration system leaving two streams; Stream G: filter cake and Product 2-1: recovered fats.

Thus, the process of the invention allows the recovery of fats, without the use of hydrocarbons as solvents and of the lesser components found in the earths, as well as the subsequent use of the earths.

In an additional object of the present invention, it is a low energy cost process, and where the greatest possible amount of water is reused.

The present invention meets these needs and provides other related advantages.

### FIELD OF THE INVENTION

The field of the invention relates to the fats and biofuels sector, specifically the production of Biodiesel that allows the recovery of fats, without the use of hydrocarbons as solvents and of the lesser components found in the earth, as well as the subsequent use of the earth.

It is a low-energy process, where the greatest possible amount of water is reused.

### BACKGROUND OF THE INVENTION

In the fats and biofuels sector, specifically biodiesel production, when seeking to improve quality, earths are used in most cases for the process of removing minor components of high polarity that affect the quality of oils and biofuels. Today, these processes have different schemes that allow them to recover the vast majority of fats that remain impregnated in the earths, however, despite this, the earths are left with high organic loads, the vast majority of which are fats.

Because of this characteristic, it ceases to be a mineral waste and becomes a waste that must be managed comprehensively. Today, it is used in composting, or confined burials are used for its final disposal, generating an expense in waste management for these industries in Colombia and around the world.

There are several developments in the industry that deal with the recovery of used earths, but they do not allow the complete recovery of fats, without the use of hydrocarbons as solvents.

The prior art discloses in Patent U.S. Pat. No. 1,851,627 to Hartley, a process wherein used earth (finely divided bleaching earth) is treated with a suitable solvent to remove most of the oil and then mixed with a suitable amount of water to form a mass at a relatively high temperature. steam is generated at a sufficient rate and in sufficient quantity to make the mass porous and at the same time decrease its density. The mass is then fed into a furnace where it is subjected to a temperature of 260° C. to 815° C. and then into a multi-shelf furnace where it is subjected to temperatures in the range of 371° C. to 871° C. in the presence of air regulated to ensure proper combustion of the carbonaceous materials contained in the earth.

The Patent U.S. Pat. No. 5,256,613 to Pieter et al., describes a process for regenerating spent bleaching earth particles containing organic material resulting from the processing of edible oil, wherein said process comprises feeding said spent bleaching earth particles and oxygen into a fluidized bed of inert granular material, the height of said fluidized bed being such that a sufficient residence time is provided to oxidize essentially all of said organic material and being such that the temperature in the freeboard above said fluidized bed is less than 1000° C., the amount of said oxygen fed to said fluidized bed being greater than the stoichiometric amount required for complete oxidation of said organic material; wherein the height of said fluidized bed is such that the temperature rise in the freeboard above said fluidized bed is less than 100° C. relative to the temperature of said fluidized bed and wherein said inert granular material is sand. According to this prior, it is possible to bleach earth, but the process is not complete, so it cannot be reused. Under this precedence, fatty products are not achieved.

In contrast, the process of the present invention allows the treatment of these earths and the reuse of mineral earths in the process. The invention also produces fatty products and other products in smaller proportions that have commercial value and generate value for this waste, which today is an expense for this industrial sector.

Currently, the RFS regulations in the USA and the RED regulations in the EU promote the use of biofuels derived from second-generation raw materials. That is, biofuels produced from raw materials that do not compete or are not suitable for food. Due to these regulations and in the case of biodiesel, the demand for raw materials such as used vegetable oils, waste from the processing of vegetable oils and all types of residual vegetable fats has increased significantly. This is why the present invention provides a solution aligned with this growing demand, allowing the recovery of vegetable fats impregnated in used filtration earths through a clean and economic process.

Solvent extraction currently performed on Spent Bleaching Earths SBE, is a process where solvents such as hexane, toluene and similar are used to extract the grease residues found in the earth. This process has the disadvantages of using solvents with a low boiling point, which are very volatile and explosive; in some cases they are not approved solvents for the food industry, or their acceptable levels are very low, the desolventization process being very demanding and they are generally solvents that are not environmentally friendly; the equipment required for these processes is high risk, it must be explosion-proof and the risk of fire or explosion is very high; they are consequently expensive equipment and require high standard control and safety systems and highly trained and qualified personnel; and, supercritical fluid extractions are considered solvent extraction, but the cost of the equipment is excessively high. Hence the proposed process makes a lot of sense compared to a solvent extraction process.

The extraction of organic matter from earths using current technology is done with hydrocarbon-based solvents. Therefore, it is necessary to create a technology that does not use hydrocarbon solvents.

Extraction with current technology only extracts non-polar organic components. A growing need, therefore, is to be able to remove components of all polarities.

Current technology leaves traces of hydrocarbon-based solvents. Therefore, it is necessary to create a technology that does not leave residues other than moisture in the organic part.

Current technology does not allow the reuse of the earth that results from the process, because it is contaminated with organic matter. New technology, therefore, must allow for the reuse of earth or its application for other industrial uses.

Therefore, there is a need for an effective and high-performance solution for the treatment of used filtration earths in the vegetable fats and biofuels sector.

### DESCRIPTION OF THE INVENTION

The present invention relates to an industrial process for treating used filtration earths in the vegetable fats and biofuels sector, for the recovery of fats, earths and other valuable components.

### DESCRIPTION OF FIGURES

In order to further clarify the invention and its advantages compared to the known art, the possible illustrative and non-limiting embodiments of the application of said principles are described below with the aid of the attached drawings.

FIG. 1 illustrates a diagram of the treatment process according to the present invention.

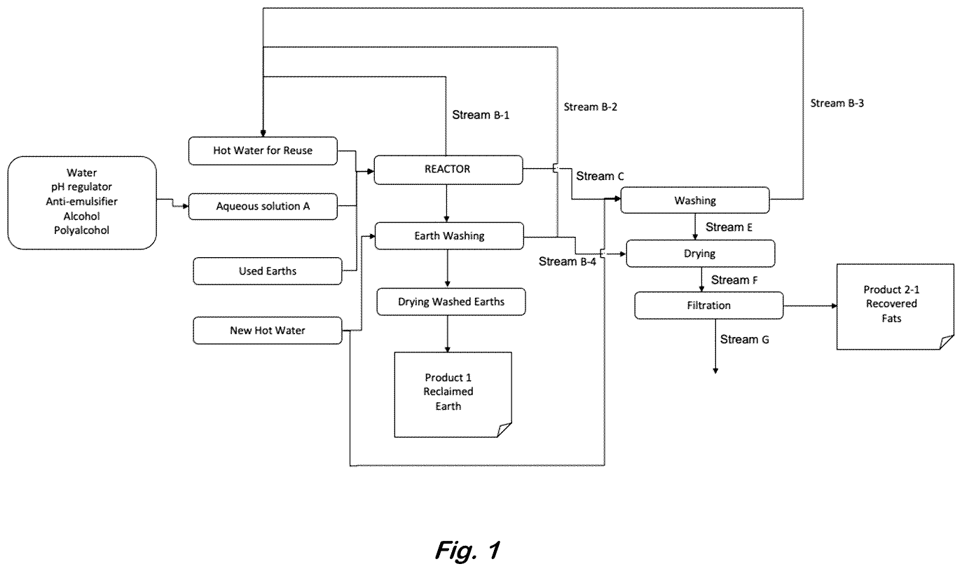

### PREFERRED EMBODIMENT OF THE INVENTION

In particular, the present invention relates in a general manner to an industrial process that includes the preparation of aqueous solution A using 1 to 10 times in Kg with respect to the earth in Kg, where the solution is mainly composed of hot water, pH regulating additive, anti-emulsifier and a mono-alcohol or poly-alcohol or mixtures thereof.

The used filtration earths are added to a stirred reactor that previously has an aqueous solution A, with stirring and at a determined temperature and time, subsequently the product found in the reactor is subjected to a separation process and three streams emerge; stream A: Bottom Earths, stream B-1: Water and interface and stream C: supernatant organic materials.

The treatment of Stream A is subjected to washing with water at temperature and agitation in a reactor that allows the dispersion of the earth, then it is passed to a solids decantation system and two streams emerge; stream D: Washed earth and stream B-2: washing water.

The treatment of Stream C is sent to washing by different methods, mixer and dynamic, column washing, washing with a packed column or drip washing at temperature and from this process two streams emerge; stream E: light phase of organic material and stream B-3: washing water.

The treatment of Stream E is carried out in vacuum drying equipment at a temperature and two streams emerge from this stage: stream F and B-4.

The treatment of Stream D is subjected to solids drying by different methods, such as thermal belt, rotary kiln or any other method available for drying solids, leaving Product 1, dry recovered earth.

The treatment of Stream F is allowed to cool and is subsequently mixed in a reactor with agitation of Product 1. It is passed through a filtration system leaving two streams; Stream G: filter cake and Product 2-1: recovered fats.

The process according to the present invention consists of:
i. Stage one of preparation of aqueous solution A where the aqueous solution is prepared using 1 to 10 times in Kg with respect to the amount of earth to be processed in Kg, where the solution is mainly composed of hot water between 35° C. and 100° C. and contains between 00 ppm to 50,000 ppm of pH regulating additive, to have a pH between 1 and 5 units, contains between 0 and 10,000 ppm of anti-emulsifier and finally contains between 0 and 50% of a mono-alcohol or poly-alcohol or mixtures thereof, where this formulation varies according to the type of earth and the contaminants that it has, after validation in the laboratory;
ii. Stage two of separation, where the used filtration earths are added to a reactor with stirring that previously has the aqueous solution A obtained in stage one (i) in the reactor maintaining the stirring and the temperature between 35° to 100° C., for a time of 1 min to 120 min, subsequently the product that is in the reactor is subjected to a separation process that can be carried out in a decanter, centrifuge or static or dynamic decanter, with lamellae or any other system that contributes to the separation, where three currents come out of the separation; current A: bottom earths, current B-1: water and interface and current C: supernatant organic materials;
iii. Stage three of washing and decantation where treatment of stream A is subjected to washing with water between 35° C.-100° C. agitation in a reactor that allows the dispersion of the earth, where it subsequently passes to a solids decantation system and two streams emerge; stream D: washed earth and stream B-2: washing water;
iv. Stage four of washing where stream C is sent to washing by different methods, washing by static mixer, washing by dynamic mixer, washing in a column, washing with a packed column or drip washing at a temperature between 35° C. and 100° C., from this process two streams come out; Stream E: light phase of organic material and stream B-3: washing water;
v. Stage five of drying where stream E is taken to a vacuum drying equipment between 1 mbar and 400 mbar at a temperature of 30° C. to 120° C., where from this stage five two streams emerge; stream F and stream B-4.
vi. Stage six of drying where stream D is subjected to solids drying by different methods, such as thermal belt, rotary kiln or any other method available for drying solids, leaving the dry reclaimed earth product called Product 1; and,
vii. Stage seven of mixing and filtration where stream F is allowed to cool between 15° C. and 50° C., then it is mixed in a reactor with stirring with 0.5% to 30% of the dry recovered earth product—Product 1—and is passed through a Sharplex®, Niagara® type filtration system, filter press or any other that carries out this process, leaving two streams; stream G: filter cake and Product 2-1 is obtained: recovered fats.

According to the present invention, the pH regulator of step one (i) may comprise a phosphate buffer. The anti-emulsifier may be chosen from cocationic polyacrylamide terpolymers (CoCationic polyacrylamide terpolymers) from Dow Chemical®, Monoalcohol: 2-Hexanol or a Polyalcohol: Propylene Glycol.

The products obtained according to the process described above then obtain:
a. Product 1: Dry reclaimed earth product.
b. Product 2.1: Product of raw material fats for biofuels or oleochemicals.
c. Streams B (1,2,3,4): Are reused for the preparation process of Aqueous Solution A.

### EXAMPLE 1

Filtration earth for use in Biodiesel purification.
1. Preparation of aqueous solution A: The aqueous solution is prepared using 1 to 10 times, preferably 3 to 5 times in Kg with respect to the amount of earth to be processed in Kg, the solution is composed mainly of hot water between 35° C. and 100° C., preferably between 60-80° C., it contains between 00 ppm to 50000 ppm, preferably between 1000 to 10000 ppm of pH regulating additive, preferably a Phosphate buffer, to have a pH between 1 and 5 units, it contains between 0 and 10000 ppm, preferably 50 to 2000 ppm of anti-emulsifier and finally it contains between 0 and 50%, preferably between 1 and 10% of propylene glycol. Anti-emulsifier: Dow Chemical: Cocanic polyacrylamide terpolymers (CoCationic polyacrylamide terpolymers);
2. The used filtration earths are added to a stirred reactor that previously has an “aqueous solution A”, in the reactor the stirring and the temperature between 35° to 100° C. are maintained, preferably between 50 to 80° C. for a time of 1 min to 120 min, preferably between 50 and 90 min, subsequently the product that is in the reactor is subjected to a separation process that can be carried out in a decanter, centrifuge or static or dynamic decanting, with lamellae or any other system that helps the separation. Three streams emerge from the separation; Stream A Bottom Earths, Stream B-1 Water and interface and Stream C supernatant organic materials.
3. Treatment of Stream A: This stream is subjected to washing with water between 35° C.-100° C., preferably between 50 and 80° C., agitation in a reactor that allows the dispersion of the earth, then it is passed to a solids decantation system and two streams emerge; Stream D washed earth and stream B-2 washing water.
4. Treatment Stream C: this stream is sent to washing by different methods, static mixer, dynamic mixer, column washing, washing with packed column or drip washing at a temperature between 35° C. and 100° C., preferably between 50 and 80° C., from this process two streams emerge; Stream E light phase of organic material and Stream B-3 wash water.
5. Treatment of Stream E: This stream is taken to vacuum drying equipment between 1 mbar and 400 mbar, preferably between 20 and 200 mbar, at a temperature of 30° C. to 120° C., preferably between 70 and 120°. Two streams emerge from this stage; Stream F and stream B-4.
6. Treatment stream D: This stream is subjected to solids drying by different methods, such as thermal belt, rotary kiln or any other method available for drying solids, leaving Product 1, dry reclaimed earth;
7. Treatment stream F: this stream is allowed to cool between 15° C. and 50° C., then it is mixed in a reactor with stirring with 0.5% to 30%, preferably between 10 and 20% of Product 1. And it is passed through a filtration system such as Sharplex, Niagara, filter press or any other that carries out this process. Two streams remain; stream G filter cake and Product 2-1 Recovered fats.

In this process, 35% of fat was recovered compared to the earth. 7% of cake and 52% of dry earth were obtained.

In summary, the products obtained from Example 1 include:
Product 1: Reclaimed earth uses in low-density construction.
Product 2.1: Raw material fats for biofuels or oleochemicals.
Streams B (1,2,3,4): Are reused for the preparation process of Aqueous Solution A.

### EXAMPLE 2

### Filtration Earth for Use in Biodiesel Purification

1. Preparation of Aqueous Solution A: The aqueous solution is prepared using 1 to 10 times, preferably 3 to 4 times in Kg with respect to the amount of earth to be processed in Kg, the solution is mainly composed of hot water between 35° C. and 100° C., preferably between 60-70° C., it contains between 00 ppm to 50000 ppm, preferably between 1000 to 2000 ppm of pH regulating additive, preferably a Phosphate buffer, to have a pH between 1 and 5 units, it contains between 0 and 10000 ppm, preferably 0 to 500 ppm of anti-emulsifier and finally it contains between 0 and 50%, preferably between 0 and 5% of 2 Hexanol, Antie-mulsifier: Dow Chemical: Cocanic polyacrylamide terpolymers (CoCationic polyacrylamide terpolymers);
2. The used filtration earths are added to a stirred reactor that previously has an “aqueous solution A”, in the reactor the stirring and the temperature between 35° and 100° C. are maintained, preferably between 50 and 70° C. for a time of 1 min to 120 min, preferably between 50 and 90 min, subsequently the product that is in the reactor is subjected to a separation process that can be carried out in a decanter, centrifuge or static or dynamic decanting, with lamellae or any other system that helps the separation. Three streams emerge from the separation; Stream A Bottom Earths, Stream B-1 Water and interface and Stream C supernatant organic materials;
3. Treatment of Stream A: This stream is washed with water between 35° C.-100° C., preferably between 50 and 70° C., agitated in a reactor that allows the dispersion of the earth, then it is passed to a solids decantation system and two streams emerge; Stream D washed earth and Stream B-2 wash water;
4. Treatment Stream C: this stream is sent to washing by different methods, static mixer, dynamic mixer, column washing, washing with a packed column or drip washing at a temperature between 35° C. and 100° C., preferably between 50 and 70° C., from this process two streams emerge; Stream E light phase of organic material and Stream B-3 wash water;
5. Treatment of Stream E: This stream is taken to vacuum drying equipment between 1 mbar and 400 mbar, preferably between 20 and 200 mbar, at a temperature of 30° C. to 120° C., preferably between 70 and 120°. Two streams emerge from this stage; Stream F and stream B-4;
6. Treatment stream D: This stream is subjected to solids drying by different methods, such as thermal belt, rotary kiln or any other method available for drying solids, leaving Product 1, dry reclaimed earth; and,
7. Treatment stream F: this stream is allowed to cool between 15° C. and 50° C., then it is mixed in a reactor with stirring with 0.5% to 30%, preferably between 7 and 15% of Product 1. And it is passed through a filtration system such as Sharplex, Niagara, filter press or any other that carries out this process. Two streams remain; stream G filter cake and Product 2-1 Recovered fats.

In this process, 37% of fat was recovered compared to the earth. 6% of cake and 57% of dry earth were obtained.

In summary, the products obtained from Example 2 include:
Product 1: Reclaimed earth, uses in low-density construction.
Product 2.1: Raw material fats for biofuels or oleochemicals.
Streams B (1,2,3,4): Are reused for the preparation process of Aqueous Solution A.

Thus, the process of the invention allows the recovery of fats, without the use of hydrocarbons as solvents and of the lesser components found in the earths, as well as the subsequent use of the earths.

Only some preferred embodiments of the invention have been illustrated by way of example. In this respect, it will be appreciated that the industrial process for treating spent filtration earths in the vegetable fats and biofuels sector, for the recovery of fats, earths and other valuable components, as well as the configuration arrangements can be chosen from a plurality of alternatives without departing from the spirit of the invention according to the following claims.

1. Industrial process for the treatment of used filtration earth in the vegetable fats and biofuels sector, characterized by comprising:
(i) stage one of preparation of aqueous solution A where the aqueous solution is prepared from 1 to 10 times in Kg with respect to the amount of earth to be processed in Kg, where the solution is composed mainly of hot water between 35° C. and 100° C. and contains between 00 ppm to 50,000 ppm of pH regulating additive with a pH between 1 and 5 units, between 0 and 10,000 ppm of anti-emulsifier and between 0 and 50% of a mono-alcohol or poly-alcohol or mixtures thereof depending on the type of earth and contaminants with validation in the laboratory;
(ii) stage two of separation, where the used filtration earths are added to a reactor with stirring that previously has the aqueous solution A obtained in stage one (i) in the reactor maintaining the stirring and the temperature between 35° to 100° C., for a time of 1 min to 120 min, subsequently the product that is in the reactor is subjected to a separation process in a decanter, centrifuge or static or dynamic decanters, with lamellae or any system that contributes to the separation, where three currents come out of the separation; current A: bottom earths, current B-1: water and interface and current C: supernatant organic materials;
(iii) Stage three of washing and decantation where treatment of stream A is subjected to washing with water between 35° C.-100° C., agitation in a reactor that allows the dispersion of the earth, where it subsequently passes to a solids decantation system and two streams emerge; stream D: washed earth and stream B-2: washing water;
(iv) stage four of washing where stream C is sent to washing by different methods, washing by static mixer, washing by dynamic mixer, washing in a column, washing with a packed column or drip washing at a temperature between 35° C. and 100° C., from this process two streams emerge; Stream E: light phase of organic material and stream B-3: washing water;
(v) Stage five of drying where stream E is taken to a vacuum drying equipment between 1 mbar and 400 mbar at a temperature of 30° C. to 120° C., where from this stage five two streams emerge; stream F and stream B-4;
(vi) Stage six of drying where stream D is subjected to solids drying by different methods, such as thermal belt, rotary kiln or any solids drying method and the dry reclaimed earth product called Product 1 is obtained; and,
(vii) Stage seven of mixing and filtration where stream F is allowed to cool between 15° C. and 50° C., then it is mixed in a reactor with stirring with 0.5% to 30% of the dry recovered earth product—Product 1—and is passed through a filter press type filtration system or any other that carries out this process, leaving two streams; stream G: filter cake and Product 2-1 is obtained: recovered fats.

2. Industrial process for the treatment of used filtration earths in the vegetable fats and biofuels sector according to claim 1, characterized in that the pH regulator of stage one (i) comprises a phosphate buffer.

3. Industrial process for the treatment of used filtration earths in the vegetable fats and biofuels sector according to claim 1, characterized in that the anti-emulsifier is chosen from cocationic polyacrylamide terpolymers, monoalcohol: 2-hexanol or a polyalcohol: propylene glycol.

4. Industrial process for the treatment of used filtration earths in the vegetable fats and biofuels sector according to claim 1, characterized in that the products obtained comprise a Product 1 of dry reclaimed earths; a Product 2.1 of fats from raw material for biofuels or oleochemicals; and, streams B1, B2, B3 and B4 of reuse in the process of preparation of aqueous solution A of stage one (i).
